(19) United States
(12) Patent Application Publication
(10) Pub. No.: US 2026/0134114 A1
(43) Pub. Date: May 14, 2026

(54) FILE FORMAT-BASED TRANSPARENT ENCRYPTION ON BIG DATA

(71) Applicants: Lemon Inc., Grand Cayman (KY); Beijing Zitiao Network Technology Co., Ltd., Beijing (CN)

(72) Inventors: Zhongyan QIU, Culver City, CA (US); Ence WANG, Beijing (CN); Zhi DONG, Culver City, CA (US); Ke SUN, Beijing (CN); Shaoxiong ZHOU, Beijing (CN); Yumin CHEN, Culver City, CA (US); Wanyi ZHANG, Culver City, CA (US); Ruojun ZHAO, Culver City, CA (US); Xiaonan MENG, Beijing (CN)

(21) Appl. No.: 19/018,920

(22) Filed: Jan. 13, 2025

Related U.S. Application Data
(63) Continuation of application No. PCT/CN2024/131353, filed on Nov. 11, 2024.

(51) Int. Cl. G06F 21/60; G06F 21/62

(52) U.S. Cl. CPC G06F 21/602; G06F 21/6218

(57) ABSTRACT

This specification relates to file format-based transparent encryption tailored for big data. In some aspects, a method includes receiving, by one or more computing devices, a write request including a table with one or more columns to be stored in a storage device, wherein each column includes a number of pages; generating a column key for each column and a page key for each page including sensitive information; encrypting (i) each page including sensitive information with a corresponding page key and (ii) each column with a corresponding column key; generating wrapped keys for the column keys and page keys and storing the wrapped keys into a key file; storing the encrypted columns into a data file of the storage device and storing the wrapped keys in a separate key file; and storing a reference to the key file in a file footer of the data file.

### CROSS-REFERENCE TO RELATED APPLICATION(S)

This application claims priority to International Patent Application No. PCT/CN2024/131353 filed Nov. 11, 2024, the disclosure of which is incorporated herein by reference in its entirety.

### TECHNICAL FIELD

This specification generally relates to security and privacy of big data.

### BACKGROUND

Big data technologies are widely used across various fields. These technologies handle data that is large and complex. Parquet is a columnar storage file format optimized for use with big data processing frameworks, such as Apache Hadoop, Apache Spark, and Apache Hive, etc. While big data technologies are widely used, they also raise security concerns. A traditional big data encryption solution, such as the original Parquet encryption solution, is a client-side encryption, which requires the client to explicitly set the encryption configurations. This involves specifying encryption algorithms, managing encryption keys, and ensuring that data is encrypted both in transit and at rest. However, not every client has the required security background to handle these tasks effectively.

Additionally, traditional big data encryption cannot be incorporated with a scalable key access control mechanism. The traditional big data encryption uses the same master key to encrypt data keys for different tables, and thus cannot achieve precise access control. For example, a malicious user, who has permission to read Table B but no permission to read Table A, can request to read Table A. The file systems in the traditional big data encryption solutions are shared and cannot be trusted. For example, many companies might store their data in a public cloud, which opens the door for malicious users to impersonate and get sensitive data from the public cloud.

### SUMMARY

This document describes technologies related to file format-based transparent encryption tailored for big data. These technologies take into account the specific file formats within a user's big data ecosystem and encrypt data at the smallest unit level of these formats. Data keys for encryption are generated on the server-side to provide seamless transparency. The computing system on the server-side centrally manages these data keys and other keys involved in the encryption process. A schema-based permission model is employed for precise access control, requiring different user privileges to access data with different security levels. Envelope encryption is used to make the solution scalable and maintainable, particularly for large enterprises. Encrypted data and data keys are stored separately, with the encrypted data linked to a reference of the data key information. This ensures that encrypted data files can be copied or moved across different environments without losing the ability to access or decrypt them.

The technologies described in this document provide file format-based transparent encryption on big data that is tailored to fit the specific file formats of a user's big data ecosystem. The technologies centralize key management to offer seamless transparency to end users and simplify both the writing and reading process of big data. Specifically, the server-side computing system generates data keys used to encrypt the big data, eliminating the need for users to have a security background. In the encryption process, fine-grained encryption of the smallest data units within the file formats is performed, which allows precise access control and offers various encryption modes for flexibility.

Furthermore, the technologies implement stringent access control through schema-based permissions, ensuring robust data security by protecting encryption keys and preventing unauthorized users from accessing restricted data.

Additionally, the described technologies store the encrypted data and the data keys separately, linking the encrypted data with a reference to the data key information. This allows data files containing encrypted data to be copied or moved across different environments while maintaining the ability to access and decrypt them.

In one aspect, this document describes a method for file format-based transparent encryption on big data. The method includes receiving, by one or more computing devices, a write request including a table with one or more columns to be stored in a storage device, wherein each column includes a number of pages; generating a column key for each column and a page key for each page including sensitive information; encrypting (i) each page including sensitive information with a corresponding page key and (ii) each column with a corresponding column key; generating wrapped keys for the column keys and page keys and storing the wrapped keys into a key file; storing the encrypted columns into a data file of the storage device and storing the wrapped keys in a separate key file; and storing a reference to the key file in a file footer of the data file.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or caused the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the key file can be in a dedicated space in a shared file system that requires permission to access.

In some implementations, each wrapped key can include an identifier of a data key and location information of data that is encrypted using the data key. In some implementations, the wrapped key can be signed using a wrapped key signing key.

In some implementations, the reference can indicate a storage location of the key file.

In some implementations, each data key, included in the column keys and the page keys, can be encrypted using a master key. The master key can be encrypted using a root key.

In some implementations, the method can include receiving, from a requestor, a read request for retrieving a page from the table; obtaining, from the data file, an encrypted page corresponding to the requested page; obtaining a storage location of the key file from the file footer of the data file; identifying, in the key file, the wrapped key corresponding to the requested page; obtaining a data key used to encrypt the requested page by unwrapping the wrapped key; using the data key to decrypt the encrypted page to obtain the requested page in plaintext; and returning the requested page to the requestor.

In some implementations, the table can be divided into columns and sensitive rows. Separate column privileges can be required to read each column except the sensitive rows and separate row privileges are required to read each sensitive row. A permission model to access table data can include four hierarchies: “table privilege,” “table +row privilege,” “column privilege,” and “column +row privilege.”

Particular implementations of the subject matter described in this specification can be implemented so as to realize one or more of the following advantages. The technologies described in this document provide file format-based transparent encryption on big data. The described technologies enable encryption of the smallest data unit within the file format and offer various encryption modes for flexibility. The described technologies fit the empirical model for the user's particular big data ecosystem by considering the file formats of the ecosystem. By enabling encryption of the smallest data unit, encryption in fine granularity is achieved, which allows for precise access control and the ability to perform cryptographic shredding.

Further, the described technologies centralize key management for easy access to achieve seamless transparency for end users. By providing end-to-end transparency to the end users, the technologies do not require end users to have security background, and thus simplify the writing and reading process for the end users while ensuring the security of the data.

Furthermore, the described technologies store the encrypted data and the data keys separately, while attaching a reference to the data key information to the encrypted data. As a result, the data files including the encrypted data can be copied or moved across different environments without losing the ability to access or decrypt them.

The described technologies also provide stringent access control through a schema-based permission to ensure robust data security. The technologies protect the encryption key and close the gap for malicious users to read data that they do not have permission to.

It is appreciated that methods and systems in accordance with the present description can include various combinations of the aspects and features described herein. That is, methods and systems in accordance with the present description are not limited to the specific combinations of aspects and features specifically described herein, but also may include other combinations of the aspects and features provided.

The details of one or more implementations of the present description are set forth in the accompanying drawings and the description below. Other features and advantages of the present description will be apparent from the description and drawings, and from the claims.

### BRIEF DESCRIPTION OF DRAWINGS

FIG. 1 is an example environment for file-format based transparent encryption on big data.

FIG. 2 is a flow diagram of an example process for writing table data in file-format based transparent encryption.

FIG. 3 is a table example with sensitive rows in a schema-based permission model.

FIG. 4 is an example of a wrapped key.

FIG. 5 is a block diagram of an example envelope encryption model incorporating a three-layer key hierarchy.

FIG. 6 is a block diagram showing an example file footer of a data file with reference to the corresponding key file.

FIG. 7 is a block diagram of an example process of secret management.

FIG. 8 is a block diagram of an example process of root key rotation.

FIG. 9 is an example of a data file generated in response to the written request.

FIG. 10 is a flow diagram of an example process for reading table data in file-format based transparent encryption.

FIG. 11 illustrates block diagrams of example computing devices.

FIG. 12 shows an example empirical model.

### DETAILED DESCRIPTION

This specification describes technologies for file-format based transparent encryption on big data. The technologies consider the specific file formats of a user's big data ecosystem and encrypt the data in the smallest data unit of the file formats. The technologies generate the data keys used to encrypt the data on the server side to offer seamless transparency. The technologies centrally manage the data keys and other keys generated in the encryption process. The technologies employ schema-based permission models for precise access control, where a user needs different privileges to read data of different security levels. The technologies also employ scalable envelope encryption that employs a three layer key hierarchy that makes the solution scalable and maintainable, particularly for large enterprises. The described technologies store the encrypted data and the data keys separately, linking the encrypted data with a reference to the data key information. So that the data files containing encrypted data can be copied or moved across different environments while maintaining the ability to access and decrypt them.

In some implementations, the data ecosystem can include a data warehouse such as APACHE HIVE that supports queries and analysis of big data stored in a distributed manner, for example, based on APACHE HADOOP. The data ecosystem may include different components or services with different levels of trust. One empirical model for HIVE systems defines three layers with different levels of trust ability. At a top layer for fully trustable services, secure services such as key management are managed with stringent security conditions including access control. At a middle, semi-trustable, layer various data computation can occur including by data readers and data writers. Data readers and writers may be developed by different parties that may not incorporate security procedures to ensure trust. Furthermore, a third un-trustable layer may include other services such as third party storage, e.g., cloud storage services. Secrets, e.g., keys, are placed in the trusted services while all information sent from services that are not trusted, or semi-trusted, need to be verified.

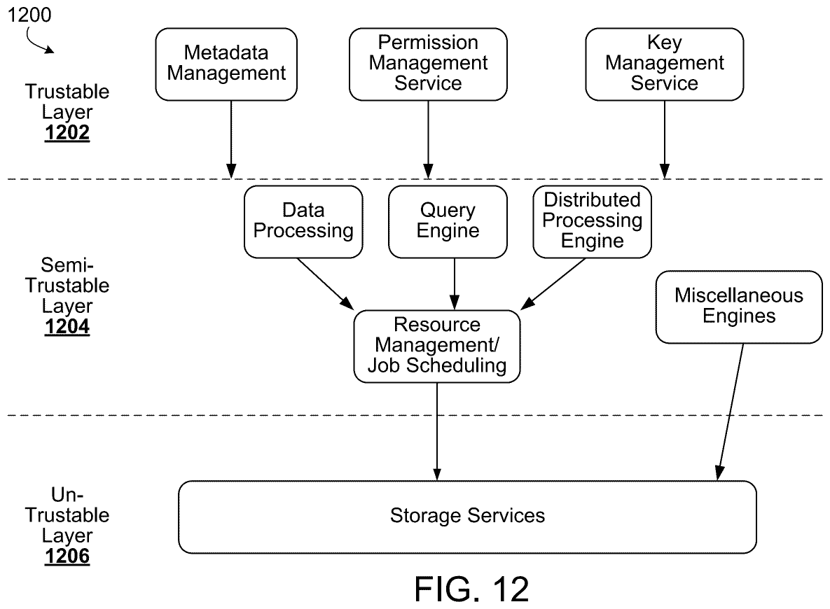

FIG. 12 shows an example of the empirical model 1200. As illustrated in FIG. 12, the empirical model 1200 includes trustable layer 1202, semi-trustable layer 1204, and un-trustable layer 1206. The trustable layer 1202 includes, for example, metadata management, permission management, and key management services. The semi-trustable layer 1204 includes services for data computation such as data processing services, query engines, distributed processing engines, and resource management and job scheduling services. The un-trusted layer 1206 includes storage services.

This three layer empirical model is informed by a set of three observable facts and two assumptions. The facts include: 1) limited data writing mediums, 2) numerous data reading mediums, and 3) decoupled storage and database layers. With respect to the limited data writing mediums, typically, a restricted number of mediums are permitted to write data files such as HIVE SQL. With respect to the numerous data reading mediums, a wide range of tools can be used to read data files from SQL interfaces, programmatic options, and direct access methods. The open-source nature of data file formats exacerbates this by enabling the creation of custom reading tools. Finally, with respect to decoupled storage and database layers, the storage layer is typically separated from the database layer and lacks awareness of the data schema, leading to inconsistency in access control. Storage can also be decentralized, further complicating the control mechanisms.

The two assumptions are that 1) data writers intend to secure data at rest, operating under the belief that leaking data would not be beneficial to them and 2) Conversely, data readers may seek to extend their access scope, which is what security solutions seek to guard against.

The following description of file formation-based transparent encryption is designed to adapt to the above empirical model with the three facts and two assumptions to provide a technological solution that provides a framework driven by six core concepts, described in detail below: granular encryption, modular key usage, trust anchoring and access control, scalable envelope encryption, and transparent encryption configuration. In the solution, all the secrets and sensitive configurations are stored and their access is managed in the trustable layer services. All the information that is persisted in the un-trustable layer has been protected by encryption or signature, which cannot be tampered with, and all of the logic and information that has been given to or running on the semi-trustable layer has been minimized and managed separately in Data Writers and Data Readers, which fits the assumptions.

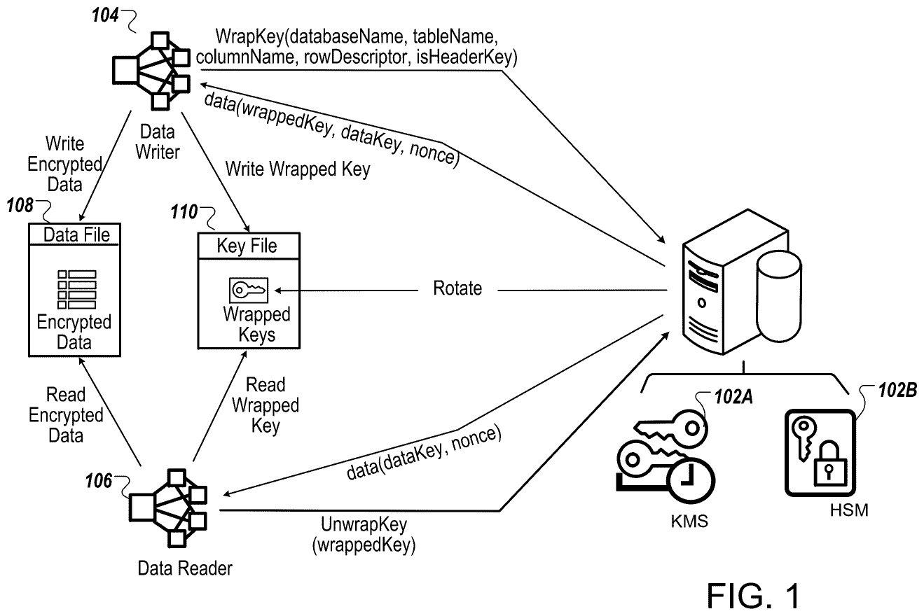

FIG. 1 is an example environment for file-format based transparent encryption on big data. The example environment 100 includes a number of components within a distributed system. The environment 100 includes one or more data writers 104 and one or more data readers 106. The environment 100 also includes one or more trusted computing devices that provide key management services including a key management system (KMS) 102A and a hardware security module (HSM) 102B. The components are communicatively coupled over a network (not shown). The network can include a local area network (“LAN”), a wide area network (“WAN”), the Internet, or a combination thereof.

In some instances, the specification refers to the services having a lower trust level, e.g., the data writers and data readers, as being on a “client side” of the environment and the trusted services, e.g., the KMS and HSM, as corresponding to a “server side” of the environment.

The data writers 104 and data readers 106 can be any suitable Internet-connected user device, e.g., a laptop or desktop computer, a smartphone, or an electronic tablet. The user device can be connected to the Internet through a mobile network, through an Internet service provider (ISP), or otherwise. Each user device is configured with software, which will be referred to as a client or as client software, that in operation can access the components of the environment 100.

Each data writer 104, in response to obtaining table data that is to be written into a storage device, obtains one or more data keys used to encrypt the table data. The data keys will be stored in the KMS 102A. The data writer calls the KMS 102A to generate keys and provides data location information for the table data being stored, including, for example, database, table, column, and row descriptor. The KMS 102A returns one or more data keys to the data writer 104. The KMS 102A further wraps the identifiers (IDs) of the data keys and the corresponding data location information in a wrapped key. The KMS 102A returns the wrapped key to the data writer 104, which stores the wrapped key in separate key file 110. The wrapped key is a data model that ensures authenticity of the information passed from the data readers. The wrapped key can take the form of a JSON web token where the payload holds a claim of what the data keys are and where the data come from (e.g., the data location information). The KMS 102A signs the token with a private key, which can be referred to as a wrapped key signing key.

The data writer 104 uses the generated data key(s) to encrypt the table data. The encrypted data are written into a data file 108 of the storage device. After encryption, the data writer 104 does not retain the data key(s).

In some embodiments, the table data are in a column-oriented table. The table includes one or more columns, each column includes a number of pages. The environment 100 enables granular encryption of the smallest data units within the file formats. Additionally, this granular encryption uses modular keys, described below, to provide access control. For example, the data writer 104 encrypts the table data in fine granularity by encrypting sensitive pages with page keys. Sensitive pages are pages having one or more rows or cells that contain sensitive data. Furthermore, each column has a separate column key that is a data key used to encrypt the data included in that column. By using the same column key for the same column, the overhead of KMS interaction is minimized.

Each data reader 106, in response to a read request for retrieving a page from the table, retrieves the encrypted data from the corresponding storage device. The data reader 106 then calls the KMS 102A to request the data key for the encrypted data. Specifically, the data reader 106 reads a wrapped key associated with the encrypted data from key file 110 and provides the wrapped key with the data key request to the KMS 102A. The KMS 102A unwraps the wrapped key to obtain the data key that is used to encrypt the requested page and provides the data key to the data reader 106. After obtaining the data key, the data reader 106 can use the data key to decrypt the encrypted requested page, e.g., into plaintext. Thus, the trusted KMS 102A controls access to the data keys by unwrapping the keys at the time of data access. The unwrapped information, e.g., the data location information, is used by the KMS 102A for access authorization, which ensures data can only be decrypted and read by users with appropriate permissions. Thus, the wrapping process provides a trust anchoring that allows the KMS to trust the data location information and other metadata passed by the data writers or data readers to the KMS.

The environment 100 employs a schema-based permission model for precise access control. A user needs separate column privileges to read each column except the sensitive rows, and separate row privileges to read each sensitive row.

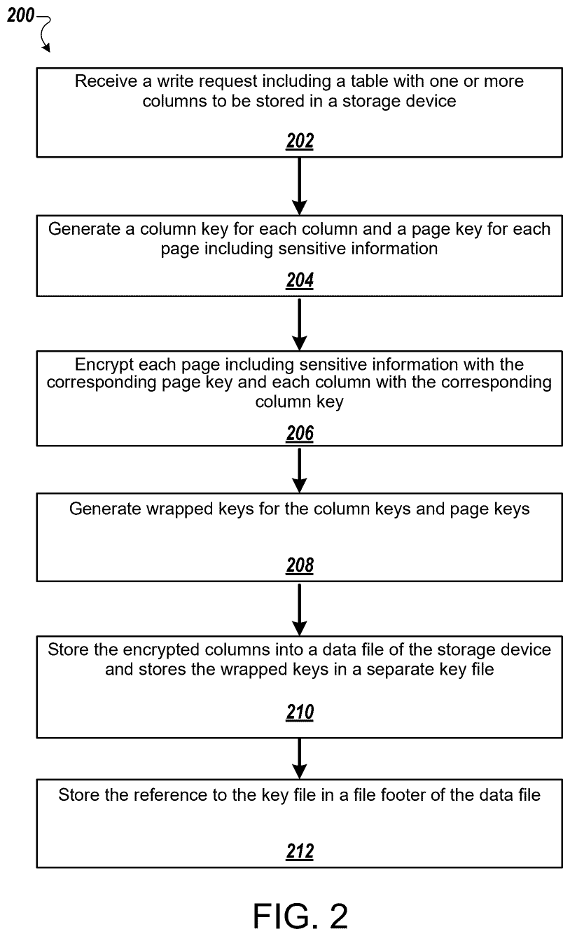

The environment 100 also employs envelope encryption to make the solution scalable. In the envelope encryption, each data key is encrypted using a master key, each master key is encrypted using a root key. One master key can be used to encrypt m data key. The data keys and the master keys are managed by the KMS 102A. The encrypted data keys are stored in KMS 102A. The master keys are encrypted by root keys which are securely stored and managed within the HSM 102B, ensuring the root keys never leave the secure environment. The HSM's sole responsibility is to protect the integrity of the root keys. One root key will be used to encrypt n master keys. FIGS. 2-10 and associated descriptions provide additional details of these implementations.

The environment 100 can include one or more computing devices, such as one or more servers or multiple distributed computing devices. In some implementations, the number of computing devices may be scaled (e.g., increased or decreased) automatically as per the computation resources needed. In some implementations, the environment 100 can implement cloud-based resources where the number of virtual machines commissioned depend on the required computational resource. The various functional components of the environment 100 may be installed on one or more computers as separate functional components or as different modules of the same functional component. For example, the various components of the environment 100 can be implemented as computer programs installed on one or more computers in one or more locations that are coupled to each through a network. In cloud-based systems, for example, these components can be implemented by individual computing nodes of a distributed computing system.

FIG. 2 is a flow diagram of an example process for writing table data in file-format based transparent encryption. For convenience, the process 200 will be described as being performed by a system of one or more computers, located in one or more locations, and programmed appropriately in accordance with this specification. For example, a computing system, e.g., encompassing the components of environment 100 including the data writer 104 of FIG. 1, appropriately programmed, can perform the process 200.

At step 202, the computing system receives a write request including a table with one or more columns to be stored in a storage device. For example, a data writer, e.g., data writer 104, receives the write request.

The write request includes the necessary data location information, such as database name, table name, column name, row descriptor, etc. The file format of the table indicates that the table is column oriented. The table includes one or more columns, each column includes a number of pages.

At step 204, the computing system generates a column key for each column and a page key for each page including sensitive information. Specifically, the data writer can obtain one or more data keys as described above with respect to FIG. 1.

Each column has a separate column key that is a data key used to encrypt the data included in that column. For example, the same data key is used for the same column.

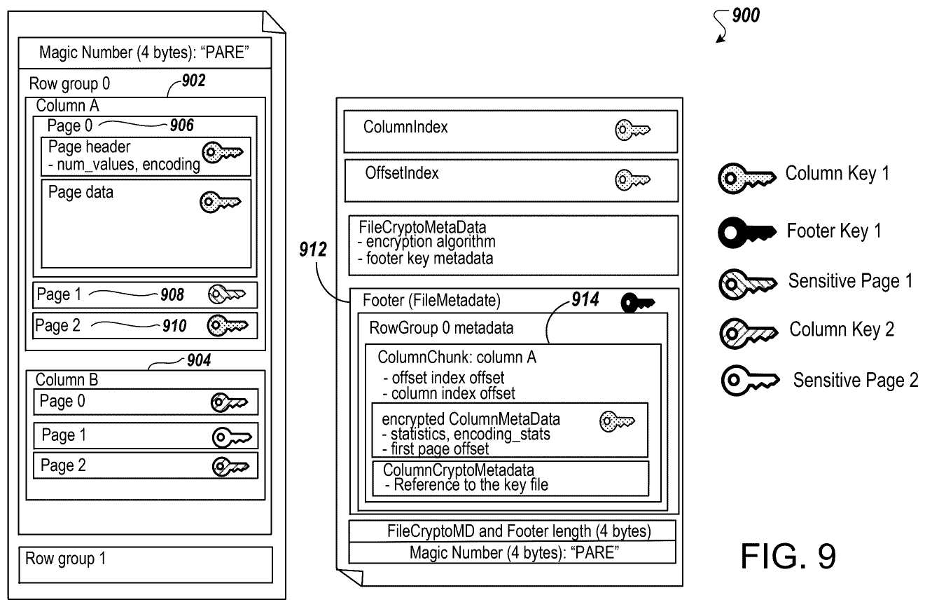

Further, the computing system generates page keys for pages having a higher security level. For example, the pages having a higher security level are pages including sensitive data, e.g., pages having one or more rows or cells that contain sensitive data. A cell is the cross of row and column. In some embodiments, information from the row descriptor is used to determine whether a row contains sensitive data. Specifically, the row descriptor includes a row value range that provides the value range of the rows in the page. For example, the row value range can be “UserID=[0, 100], which indicates that the page stores user IDs from 0-100. The KMS or other trusted service, e.g., a central configuration service, can check this row range information to determine whether there are any sensitive rows in the range. Each sensitive page has a separate page key that is a data key used to encrypt the sensitive page. Techniques for securing sensitive data using separate keys is described in greater detail below, for example, with respect to FIG. 9.

To generate the data keys including the column keys and page keys, the computing system calls a key management system (KMS) with necessary data location information, such as database name, table name, column name, row descriptor, etc. The KMS generates the data keys, and saves a mapping relationship between the generated data key and the data location information.

By generating the column keys and page keys at KMS, the end users do not need to know which keys are used for which column. The system is fully transparent.

By using the same column key for the same column, the overhead of KMS interaction is minimized.

By using page keys to encrypt pages with sensitive information, encryption in fine granularity is achieved, which allows for precise access control and the ability to perform cryptographic shredding. For example, when certain pages'sensitive information is disclosed, the sensitive information can be securely disposed of by destroying the corresponding page keys.

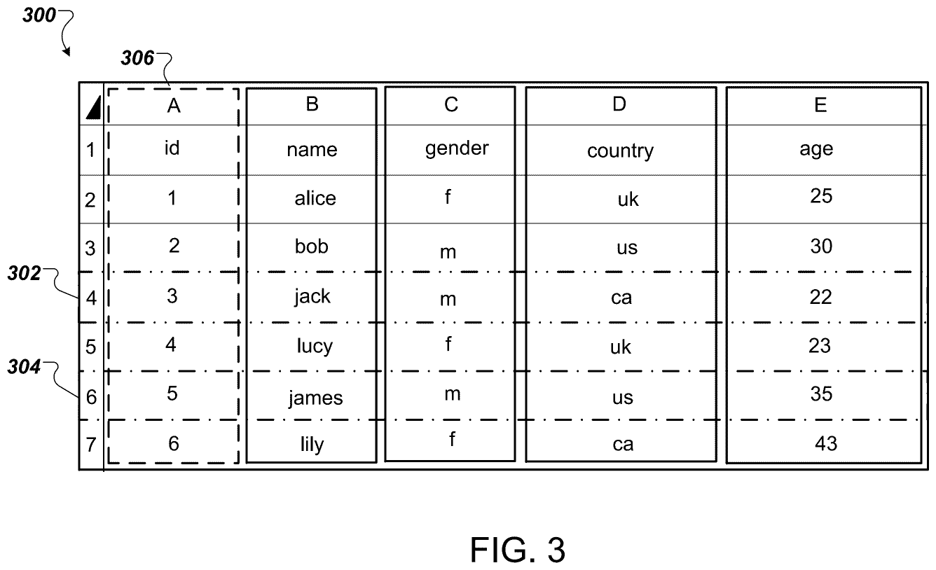

The system employs a schema-based permission model for precise access control. FIG. 3 and associated descriptions provide additional details of these implementations. The permission model enables granular encryption of the smallest data units within file formats and offers various encryption modes for flexibility.

The technologies centralize key management for easy access and auditing while maintaining stringent access control through the schema-based permission mode. The technologies ensure robust data security with minimal performance impact and seamless transparency for end-users.

Furthermore, the technologies minimize the overhead of querying data since only certain columns/pages that contain the queried data need to be decrypted.

At step 206, the computing system encrypts each page including sensitive information with the corresponding page key and each column with the corresponding column key. Specifically, if a column includes pages with sensitive information, the computing system calls the KMS to provide respective data keys used by the data writer to encrypt the pages with their corresponding page keys, and encrypt the rest of data included in the column with the corresponding column key. If a column does not include pages with sensitive information, the data writer encrypts the whole column with the corresponding column key.

At step 208, the computing system generates wrapped keys for the column keys and page keys and stores the wrapped keys into a key file. Specifically, as described above, the KMS wraps the data keys and provides the wrapped keys to the data writer, which then stores the wrapped keys in a separate client-side key file.

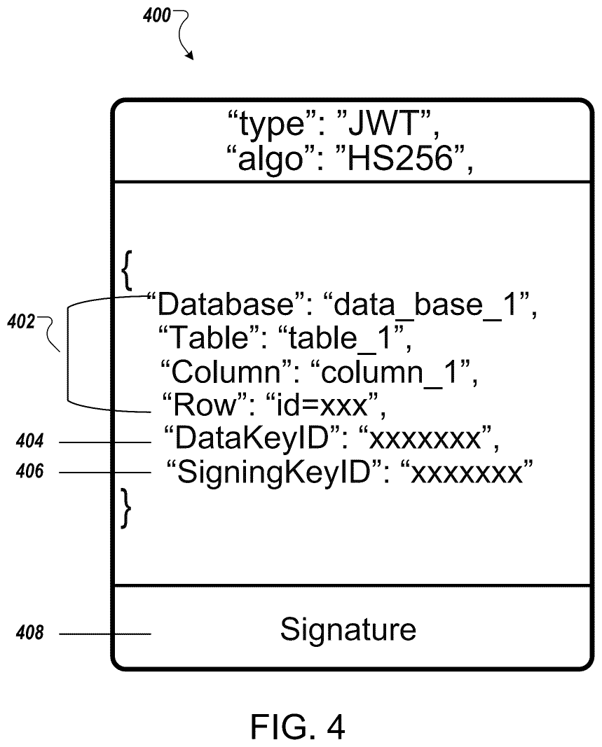

The computing system generates a wrapped key for each data key. Each wrapped key includes an identifier (ID) of a data key and location information of data that is encrypted using the data key. In other words, the data key identifier (ID) and the corresponding data location information are wrapped in an object called a wrapped key. The KMS signs the wrapped key using a private key, e.g., a wrapped key signing key, to generate a signature. The signature is attached to the wrapped key. FIG. 4 and associated descriptions provide additional details of wrapped keys.

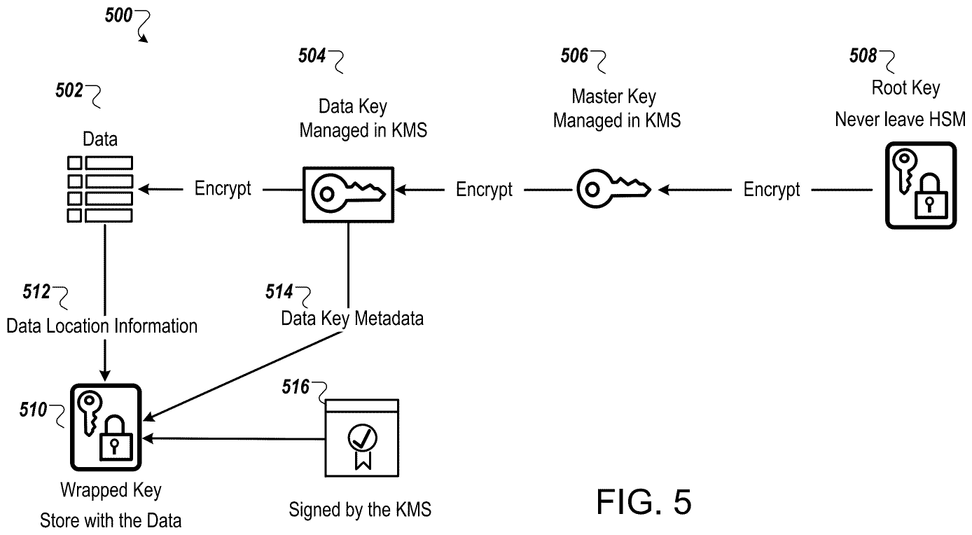

In some embodiments, the computing system uses envelope encryption according to a three layer key hierarchy that makes the solution scalable and maintainable, particularly for large enterprises. In this modular encryption different encryption mechanisms and storage media are used. For example, each data key is encrypted using a master key and each master key is encrypted using a root key. The encrypted data keys, the master keys, and the root keys are stored on the server side. In particular, the data keys are stored in a data key store, the master keys are stored in a master key store. The data key store and the master key store can be on the KMS. The root keys are stored in a root key store on the HSM. The wrapped keys are stored on the client side key file, which may be associated with the untrusted or semi-trusted services, e.g., the data writer and data reader, rather than stored in the trusted KMS. Separating the data key store, master key store, and root key store can improve security and efficiency and provides a more granular control over storage and security of the different keys. In particular, each store can have different security levels that satisfy particular security standards that allow for some keys to be more securely stored than others, which reduces security costs. FIG. 5 and associated descriptions provide additional details of the envelope encryption. The wrapped key signing keys are also stored on the server side.

At step 210, the data writer of the computing system stores the encrypted columns into a data file of the storage device and stores the wrapped keys in a separate key file.

The data file is stored in a folder path designated to the table. The key file including the wrapped keys is stored in a dedicated space in a shared file system which is owned and managed by a security team. People need permission to access the files in this dedicated space. As discussed above, the wrapped keys are in a shared file system on the client side.

At step 212, for each data file, the computing system stores the reference to the corresponding key file in a file footer of the data file.

The file footer includes the metadata of the table data, such as the offset index offset, column index offset of each column. The file footer also includes the metadata of the data keys used to encrypt the table data, such as the encryption algorithm, encryption mode and the reference to the key file.

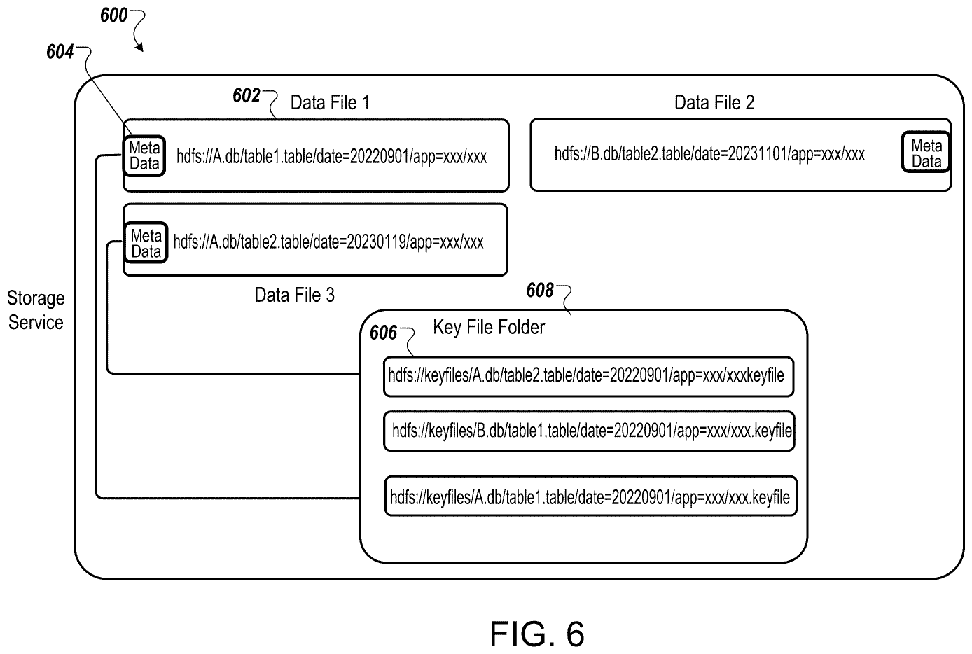

The reference to the key file is stored in key_metadata of the file footer. The reference to the key file indicates the storage location of the key file. Based on the reference, a data reader can locate the key file. As discussed above, the key file includes the wrapped keys used to encrypt the data of the data file. The wrapped keys hold information indicating what data keys are used to encrypt data from what location. After locating the key file, the data reader can further identify the data key ID for required data. The key file includes key metadata. The key metadata stores information including the key length, key id and data location, etc. FIG. 6 and associated descriptions provide additional details of the file footer with reference to the corresponding key file.

By including the wrapped keys in a separate key file and including the reference to the key file in the file footer, the technologies can ensure data readability across various storage locations as long as the reference to the key file is intact. Data files can be copied and moved across different environments without losing the ability to access or decrypt them.

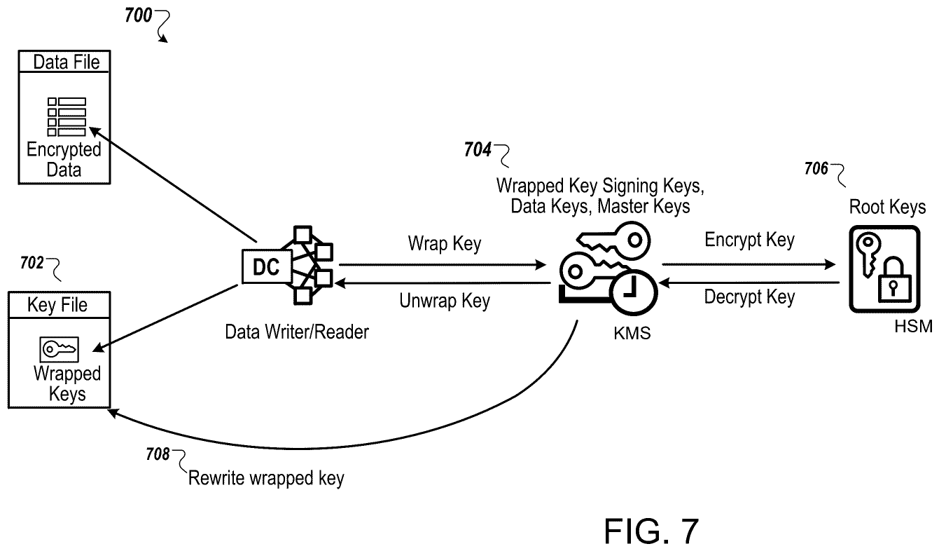

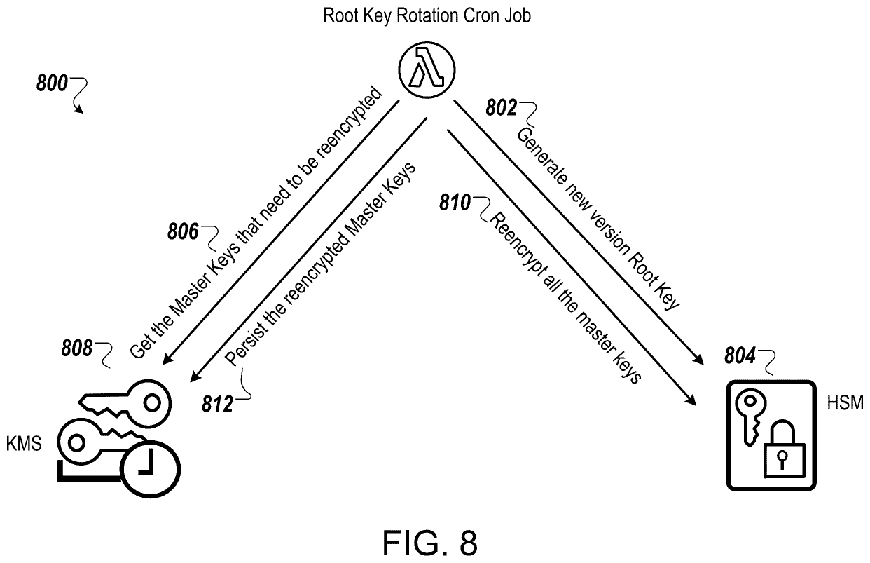

Furthermore, the centralization of key file storage allows for efficient secret rotation without the need to re-encrypt all data files, only the key files need to be updated. In particular, when rotating data keys, the data key ID or the data key version can be changed depending on how the data key file storage identifies the data keys, thus the key files are rewritten including the wrapped keys. Similarly, when rotating the wrapped key singing keys, e.g., in response to a possible leak, the wrapped keys are rewritten. FIGS. 7 and 8 and associated descriptions provide additional details of server-side secrets management and key rotation.

After the writing process is performed, a data file including the encrypted table data is generated. FIG. 9 shows an example of a data file generated in response to the written request.

The order of steps in the process 200 described above is illustrative only, and the process 200 can be performed in different orders. In some implementations, the process 200 can include additional steps, fewer steps, or some of the steps can be divided into multiple steps.

FIG. 3 is a table example 300 with sensitive rows in a schema-based permission model.

The computing system employs the schema-based permission model for trust anchoring and access control. This model divides the entire table into columns and sensitive rows. A user needs separate column privileges to read each column except the sensitive rows, and separate row privileges to read each sensitive row. For example, the permission model includes four hierarchies: “table privilege,” “table+row privilege,” “column privilege,” and “column+row privilege.”

The table example includes two sensitive rows 302, 304: a first row 302 whose ID=3 and a second row 304 whose ID=5.

A user with “table privilege” is able to read data of the entire table except the sensitive rows. Thus, in this example, the user with “table privilege” can read the data of the entire table 300 except the two sensitive rows 302, 304 whose IDs=3, 5, respectively.

A user with “table+row privilege” is able to read data of the entire table except sensitive rows of the table whose privileges are not assigned to the user. A user with table privilege and row privilege for row ID=3 (row 302) can read the data of the entire table except the sensitive row ID=5 (row 304).

A user with “column privilege” is able to read the data of the columns whose privileges are assigned to the user, except the sensitive rows. For example, a user with column privilege for column A 306 is able to read the data from column A, except data of the two sensitive rows 302, 204 included in column A 306. In other words, the user can read the values for rows with ID=1, 2, 4, 6, but cannot read the values in the rows with ID=3, 5.

A user with “column+row privilege” is able to read the data of the entire columns except sensitive rows of the columns whose privileges are not assigned to the user. For example, a user with privilege for column A 306 and row ID=3 (row 302) can read the entire column A except the sensitive row ID=5 (row 304).

By assigning specific permission based on table schema, the permission model enables fine-grained access control. Only authorized entities can access certain data segments, such as specific columns or sensitive rows within a table.

FIG. 4 is an example of a wrapped key 400. Specifically, the data key identifier (ID) 404 and the corresponding data location information 402 are wrapped in an object called a wrapped key 400. The wrapped key is a data model to ensure the authenticity of the information passed from a data reader. The wrapped key is a token, e.g., a JWT token, where the payload holds information indicating what data keys are used to encrypt data from what location (database, table, column, row range, etc.). The KMS signs the token with a private secret, e.g., a wrapped key signing key 406 to generate a signature 408. The wrapped key signing key 406 can be rotated.

FIG. 5 is a block diagram of an example envelope encryption model 500 incorporating a three-layer key hierarchy.

Specifically, the table data 502 are encrypted by data keys 504. The data keys are encrypted by master keys. One master key can be used to encrypt m data key. The data keys and the master keys are managed by the key management system (KMS). The encrypted data keys are stored in KMS.

As discussed above in FIG. 4, the wrapped keys 510 include the data location information 512, the data key metadata 514, such as the ID of the data key used to encrypt the data in corresponding to the data location information 512. The wrapped key 510 is further signed by the KMS 516 using the wrapped key signing key.

The wrapped keys are stored in a key file in a shared file system. The shared file system can use less expensive storage media, since usually the number of wrapped keys is huge.

The master keys are encrypted by root keys which are securely stored and managed within a hardware security module (HSM), ensuring the root keys never leave the secure environment. The HSM's sole responsibility is to protect the integrity of the root keys. One root key will be used to encrypt n master keys.

The values of m and n are based on the number of tables and total number of columns and the scalability of the KMS. For example, if there are 1 million tables and 100 columns in each table on average, and if m=100 and n=100, then there will be 1 million master keys and 100 thousand root keys that need to be managed centrally.

To recap, only the wrapped keys are stored on the client-side, i.e., in the key file 110. The data keys are stored in the KMS, e.g., in a data key store. The master keys are stored in the KMS, e.g., in a master key store, the wrapped key signing keys are stored in the KMS. The root keys are stored on the HSM.

FIG. 6 is a block diagram 600 showing an example file footer of a data file with reference to the corresponding key file.

As shown in the figure, the first data file (Data File 1) 602 includes metadata 604, e.g., file footer. The file footer 404 includes the reference to the corresponding key file. The Data File 1 602 includes encrypted data of a particular table that is encrypted using a set of data keys. The key file includes wrapped keys of the set of data keys. The reference to the key file 406 includes the location 606, such as a folder path, of the key file, where the key file is stored.

In some embodiments, the storage device includes multiple data files. Each data file includes a file footer. The file footer can include information referring to the location of its corresponding key file. The key files are stored in a key file folder 608 that is a dedicated space in a shared file system. People need permission to access the files in this dedicated space.

FIG. 7 is a block diagram of an example process of secret management 700. The wrapped keys are stored in a key file 702 on the “client” side. The wrapped key signing keys, data keys, and master keys are stored at KMS 704. The root keys are stored at HSM 706. As discussed above, the wrapped keys are signed using the wrapped key signing keys. In some instances, the wrapped key is rewritten 708. For example, when rotating secrets, e.g., data keys or wrapped key signing keys. For example, the wrapped keys are signed with the new wrapped key signing key.

FIG. 8 is a block diagram of an example process of root key rotation 800. The components of environment 100 of FIG. 1, appropriately programmed, can perform the process 800 by calling the KMS and HSM.

As discussed above, the master keys are encrypted using the root keys. In 802, a new root key 802 is generated by HSM 804. In 806, the master keys are obtained from the KMS 808. These master keys need to be re-encrypted using the new root keys. In 810, the master keys are re-encrypted using the new root keys. In 812, the re-encrypted master keys are persisted at KMS.

In master key rotation, a new version of master key is generated. The master key is rotated more frequently than the root key. For example, the root key is rotated 6 months to 1 year. After the new master key is generated, the data keys are re-encrypted using the new master key.

In data key rotation, a new version of the data key is generated. The data keys are usually not rotated regularly. For example, the data key rotation is triggered on demand, when a security risk is detected, e.g., the data key may have been breached. In some embodiments, when the KMS receives an unwrap key request of such a data key, the data key rotation is triggered and the corresponding data file is rewritten.

In rotation of the wrapped key signing keys, the KMS generates a new version of the wrapped key signing key when the particular wrapped key signing key has been used x times. The value of x can be set according to a user's demand on security level, the scale of data files, and other factors. In some embodiments, when the KMS receives an unwrap key request and the KMS determines that the signature has expired, the rotation of the wrapped key signing keys is triggered and the corresponding wrapped key is re-signed.

FIG. 9 is an example of a data file 900 generated in response to the written request.

The data file 900 includes encrypted data of a table. The table includes multiple columns, such as Column A 902, Column B 904, etc., In each column, there are multiple pages. For example, in Column A 902, there are three pages 906-910: Page 0(906 ), Page 1(908 ), and Page 2(910 ). Page 1(908 ) includes sensitive information. The data in Page 1(908 ) are encrypted using a page key specifically assigned to Page 1(908 ). The other pages Page 0(906 ) and Page 2(910 ) in Column A 902 do not include sensitive information and are encrypted using the column key of Column A. By applying write split and read merge technology already in place for Parquet, the system can split the sensitive rows and other rows into different pages so that from the end user perspective, they are encrypted using different keys.

The data file 900 also includes a file footer 912 that includes the metadata 914 of each column and a reference to the key file storing wrapped keys of the data keys used to encrypt the table data.

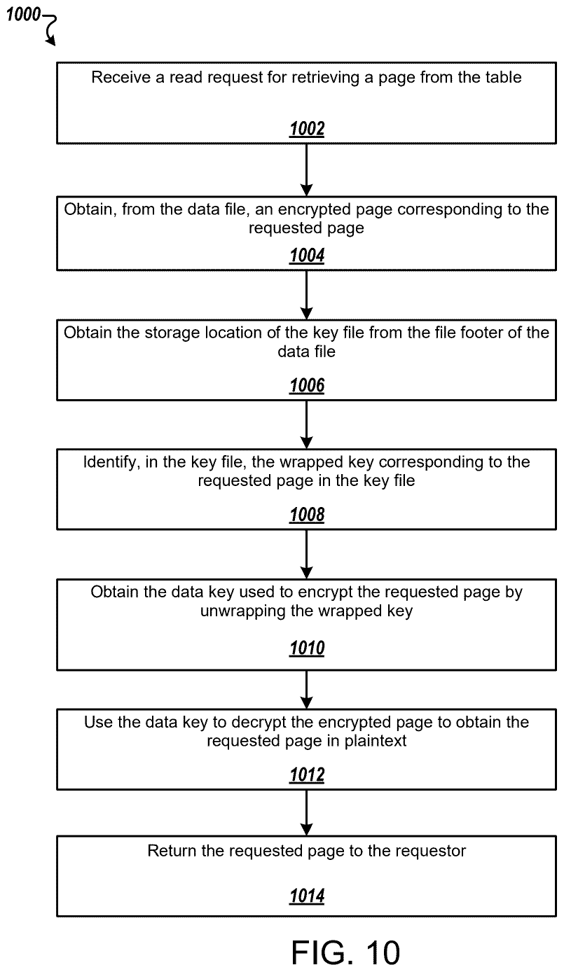

FIG. 10 is a flow diagram of an example process 1000 for reading table data in file-format based transparent encryption. For convenience, the process 1000 will be described as being performed by a system of one or more computers, located in one or more locations, and programmed appropriately in accordance with this specification. For example, a computing system, e.g., encompassing the components of environment 100 including the data reader 106 of FIG. 1, appropriately programmed, can perform the process 1000.

At step 1002, the computing system receives, from a data reader, a read request for retrieving a page from the table.

The read request includes the information identifying the requested page, such as the database ID, table ID, column, page number, row, etc.

At step 1004, the computing system obtains, from the data file, an encrypted page corresponding to the requested page.

The pages of the table data are encrypted and stored in the data file. Based on the information of the read request, the computing system obtains the encrypted page corresponding to the requested page from the data file.

To decrypt the encrypted table data, the computing system needs to obtain the data key used to encrypt the requested page. The metadata of the data keys used to encrypt the table data are included in the key file. The computing system therefore needs to access the key file to obtain the data key. As discussed above, the file footer includes the reference to the corresponding key file of the table which refers to the location of the key file.

At step 1006, the computing system obtains the storage location of the key file from the file footer of the data file.

Based on the location of the key file, the computing system can access the key file. The key file includes the wrapped keys with metadata of the data keys used to encrypt the table data.

At step 1008, the computing system can identify, in the key file, the wrapped key corresponding to the requested page.

As discussed above, the wrapped key is a token where the payload holds information indicating what data keys are used to encrypt data from what location (database, table, column, row, etc.). The computing system can identify the wrapped key corresponding to the requested page.

At step 1010, the computing system obtains the data key used to encrypt the requested page by unwrapping the wrapped key.

The computing system calls the KMS to obtain the data key. The computing system can send an unwrap key request including the identified wrapped key to the KMS. The identified wrapped key includes the ID of the data key that is used to encrypt the requested page. As discussed above, a signature is attached to the wrapped key. The signature was generated by the KMS using a wrapped key signing key. The KMS can verify the integrity of the identified wrapped key based on the signature. Specifically, the KMS identifies the corresponding wrapped key signing key based on information in the key metadata and verifies the signature using the wrapped key signing key and the information included in the wrapped key.

As discussed above, each data key is encrypted with a master key and stored at KMS. In an unwrapping process, the KMS identifies the encrypted data key based on the ID of the data key, and decrypts the encrypted data key using the master key. As a result, the KMS can obtain the plaintext of the data key used to encrypt the requested page. The KMS transmits the plaintext data key to the data reader of the computing system. Even though the KMS is trusted, to maintain security the keys are encrypted for storage at the KMS.

At step 1012, the data reader uses the data key to decrypt the encrypted page to obtain the requested page in plaintext.

At step 1014, the computing system returns the requested page to the requestor.

The order of steps in the process 1000 described above is illustrative only, and the process 1000 can be performed in different orders. In some implementations, the process 1000 can include additional steps, fewer steps, or some of the steps can be divided into multiple steps.

Embodiments of the subject matter and the actions and operations described in this specification can be implemented in digital electronic circuitry, in tangibly-embodied computer software or firmware, in computer hardware, including the structures described in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

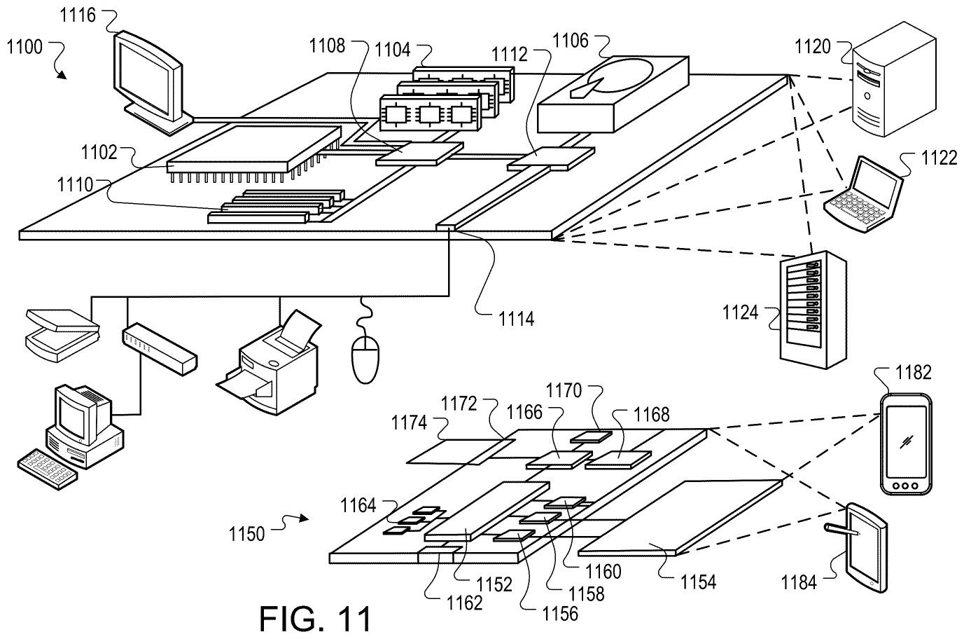

FIG. 11 shows an example of a computing device 1100 and a mobile computing device 1150 (also referred to herein as a wireless device) that are employed to execute implementations of the present description. The computing device 1100 is intended to represent various forms of digital computers, such as laptops, desktops, workstations, personal digital assistants, servers, blade servers, mainframes, and other appropriate computers. The mobile computing device 1150 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 1100 can form at least a portion of the computing system 102.

The computing device 1100 includes a processor 1102, a memory 1104, a storage device 1106, a high-speed interface 1108, and a low-speed interface 1112. In some implementations, the high-speed interface 1108 connects to the memory 1104 and multiple high-speed expansion ports 1110. In some implementations, the low-speed interface 1112 connects to a low-speed expansion port 1114 and the storage device 1106. Each of the processor 1102, the memory 1104, the storage device 1106, the high-speed interface 1108, the high-speed expansion ports 1110, and the low-speed interface 1112, are interconnected using various buses, and may be mounted on a common motherboard or in other manners as appropriate. The processor 1102 can process instructions for execution within the computing device 1100, including instructions stored in the memory 1104 and/or on the storage device 1106 to display graphical information for a graphical user interface (GUI) on an external input/output device, such as a display 1116 coupled to the high-speed interface 1108. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 1104 stores information within the computing device 1100. In some implementations, the memory 1104 is a volatile memory unit or units. In some implementations, the memory 1104 is a non-volatile memory unit or units. The memory 1104 may also be another form of a computer-readable medium, such as a magnetic or optical disk.

The storage device 1106 is capable of providing mass storage for the computing device 1100. In some implementations, the storage device 1106 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 1102, perform one or more methods, such as those described above. The instructions can also be stored by one or more storage devices, such as computer-readable or machine-readable mediums, such as the memory 1104, the storage device 1106, or memory on the processor 1102.

The high-speed interface 1108 manages bandwidth-intensive operations for the computing device 1100, while the low-speed interface 1112 manages lower bandwidth-intensive operations. Such allocation of functions is an example only. In some implementations, the high-speed interface 1108 is coupled to the memory 1104, the display 1116 (e.g., through a graphics processor or accelerator), and to the high-speed expansion ports 1110, which may accept various expansion cards. In the implementation, the low-speed interface 1112 is coupled to the storage device 1106 and the low-speed expansion port 1114. The low-speed expansion port 1114, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 1114 through a network adapter. Such network input/output devices may include, for example, a switch or router.

The computing device 1100 may be implemented in a number of different forms, as shown in the FIG. 11. For example, it may be implemented as a standard server 1120, or multiple times in a group of such servers. In addition, it may be implemented in a personal computer such as a laptop computer 1122. It may also be implemented as part of a rack server system 1124. Alternatively, components from the computing device 1100 may be combined with other components in a mobile device, such as a mobile computing device 1150. Each of such devices may contain one or more of the computing device 1100 and the mobile computing device 1150, and an entire system may be made up of multiple computing devices communicating with each other.

The mobile computing device 1150 includes a processor 1152; a memory 1164; an input/output device, such as a display 1154; a communication interface 1166; and a transceiver 1168; among other components. The mobile computing device 1150 may also be provided with a storage device, such as a micro-drive or other device, to provide additional storage. Each of the processor 1152, the memory 1164, the display 1154, the communication interface 1166, and the transceiver 1168, are interconnected using various buses, and several of the components may be mounted on a common motherboard or in other manners as appropriate. In some implementations, the mobile computing device 1150 may include a camera device(s) (not shown).

The processor 1152 can execute instructions within the mobile computing device 1150, including instructions stored in the memory 1164. The processor 1152 may be implemented as a chipset of chips that include separate and multiple analog and digital processors. For example, the processor 1152 may be a Complex Instruction Set Computers (CISC) processor, a Reduced Instruction Set Computer (RISC) processor, or a Minimal Instruction Set Computer (MISC) processor. The processor 1152 may provide, for example, for coordination of the other components of the mobile computing device 1150, such as control of user interfaces (UIs), applications run by the mobile computing device 1150, and/or wireless communication by the mobile computing device 1150.

The processor 1152 may communicate with a user through a control interface 1158 and a display interface 1156 coupled to the display 1154. The display 1154 may be, for example, a Thin-Film-Transistor Liquid Crystal Display (TFT) display, an Organic Light Emitting Diode (OLED) display, or other appropriate display technology. The display interface 1156 may include appropriate circuitry for driving the display 1154 to present graphical and other information to a user. The control interface 1158 may receive commands from a user and convert them for submission to the processor 1152. In addition, an external interface 1162 may provide communication with the processor 1152, so as to enable near area communication of the mobile

computing device 1150 with other devices. The external interface 1162 may provide, for example, for wired communication in some implementations, or for wireless communication in other implementations, and multiple interfaces may also be used.

The memory 1164 stores information within the mobile computing device 1150. The memory 1164 can be implemented as one or more of a computer-readable medium or media, a volatile memory unit or units, or a non-volatile memory unit or units. An expansion memory 1174 may also be provided and connected to the mobile computing device 1150 through an expansion interface 1172, which may include, for example, a Single in Line Memory Module (SIMM) card interface. The expansion memory 1174 may provide extra storage space for the mobile computing device 1150, or may also store applications or other information for the mobile computing device 1150. Specifically, the expansion memory 1174 may include instructions to carry out or supplement the processes described above, and may include secure information also. Thus, for example, the expansion memory 1174 may be provided as a security module for the mobile computing device 1150, and may be programmed with instructions that permit secure use of the mobile computing device 1150. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 1152, perform one or more methods, such as those described above. The instructions can also be stored by one or more storage devices, such as one or more computer-readable or machine-readable mediums, such as the memory 1164, the expansion memory 1174, or memory on the processor 1152. In some implementations, the instructions can be received in a propagated signal, such as, over the transceiver 1168 or the external interface 1162.

The mobile computing device 1150 may communicate wirelessly through the communication interface 1166, which may include digital signal processing circuitry where necessary. The communication interface 1166 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 1168 using a radio frequency. In addition, short-range communication, such as using Bluetooth or Wi-Fi, may occur. In addition, a Global Positioning System (GPS) receiver module 1170 may provide additional navigation-and location-related wireless data to the mobile computing device 1150, which may be used as appropriate by applications running on the mobile computing device 1150.

The mobile computing device 1150 may also communicate audibly using an audio codec 1160, which may receive spoken information from a user and convert it to usable digital information. The audio codec 1160 may likewise generate audible sound for a user, such as through a speaker, e.g., in a handset of the mobile computing device 1150. Such sound may include sound from voice telephone calls, may include recorded sound (e.g., voice messages, music files, etc.) and may also include sound generated by applications operating on the mobile computing device 1150.

The mobile computing device 1150 may be implemented in a number of different forms, as shown in FIG. 11. Other implementations may include a phone device 1182 and a tablet device 1184. The mobile computing device 1150 may also be implemented as a component of a smart-phone, personal digital assistant, AR device, or other similar mobile device.

Computing device 1100 and/or 1150 can also include USB flash drives. The USB flash drives may store operating systems and other applications. The USB flash drives can include input/output components, such as a wireless transmitter or USB connector that may be inserted into a USB port of another computing device.

Although a few implementations have been described in detail above, other modifications may be made without departing from the scope of the inventive concepts described herein, and, accordingly, other implementations are within the scope of the following claims.

1. A computer-implemented method comprising:
receiving, by one or more computing devices, a write request including a table with one or more columns to be stored in a storage device, wherein each column includes a number of pages;
generating a column key for each column and a page key for each page including sensitive information;
encrypting (i) each page including sensitive information with a corresponding page key and (ii) each column with a corresponding column key;
generating wrapped keys for the column keys and page keys and storing the wrapped keys into a key file;
storing the encrypted columns into a data file of the storage device and storing the wrapped keys in a separate key file; and
storing a reference to the key file in a file footer of the data file.

2. The computer-implemented method of claim 1, wherein the key file is in a dedicated space in a shared file system that requires permission to access.

3. The computer-implemented method of claim 1, wherein each wrapped key includes an identifier of a data key and location information of data that is encrypted using the data key.

4. The computer-implemented method of claim 3, wherein the wrapped key is signed using a wrapped key signing key.

5. The computer-implemented method of claim 1, wherein the reference indicates a storage location of the key file.

6. The computer-implemented method of claim 1, wherein each data key, included in the column keys and the page keys, is encrypted using a master key, and the master key is encrypted using a root key.

7. The computer-implemented method of claim 1, further comprising:
receiving, from a requestor, a read request for retrieving a page from the table;
obtaining, from the data file, an encrypted page corresponding to the requested page;
obtaining a storage location of the key file from the file footer of the data file;
identifying, in the key file, the wrapped key corresponding to the requested page;
obtaining a data key used to encrypt the requested page by unwrapping the wrapped key;
using the data key to decrypt the encrypted page to obtain the requested page in plaintext; and
returning the requested page to the requestor.

8. The computer-implemented method of claim 1, wherein:
the table is divided into columns and sensitive rows,
separate column privileges are required to read each column except the sensitive rows and separate row privileges are required to read each sensitive row,
a permission model to access table data comprises four hierarchies: “table privilege,” “table +row privilege,” “column privilege,” and “column +row privilege.”

9. A system comprising one or more computers and one or more storage devices on which are stored instructions that are operable, when executed by the one or more computers, to cause the one or more computers to perform operations comprising:
receiving, by one or more computing devices, a write request including a table with one or more columns to be stored in a storage device, wherein each column includes a number of pages;
generating a column key for each column and a page key for each page including sensitive information;
encrypting (i) each page including sensitive information with a corresponding page key and (ii) each column with a corresponding column key;
generating wrapped keys for the column keys and page keys and storing the wrapped keys into a key file;
storing the encrypted columns into a data file of the storage device and storing the wrapped keys in a separate key file; and
storing a reference to the key file in a file footer of the data file.

10. The system of claim 9, wherein the key file is in a dedicated space in a shared file system that requires permission to access.

11. The system of claim 9, wherein each wrapped key includes an identifier of a data key and location information of data that is encrypted using the data key.

12. The system of claim 11, wherein the wrapped key is signed using a wrapped key signing key.

13. The system of claim 9, wherein the reference indicates a storage location of the key file.

14. The system of claim 9, wherein each data key, included in the column keys and the page keys, is encrypted using a master key, and the master key is encrypted using a root key.

15. The system of claim 9, the operations further comprising:
receiving, from a requestor, a read request for retrieving a page from the table;
obtaining, from the data file, an encrypted page corresponding to the requested page;
obtaining a storage location of the key file from the file footer of the data file;
identifying, in the key file, the wrapped key corresponding to the requested page;
obtaining a data key used to encrypt the requested page by unwrapping the wrapped key;
using the data key to decrypt the encrypted page to obtain the requested page in plaintext; and
returning the requested page to the requestor.

16. The system of claim 9, wherein:
the table is divided into columns and sensitive rows,
separate column privileges are required to read each column except the sensitive rows and separate row privileges are required to read each sensitive row,
a permission model to access table data comprises four hierarchies: “table privilege,” “table +row privilege,” “column privilege,” and “column+row privilege.”

17. One or more computer-readable storage media encoded with instructions that, when executed by one or more computers, cause the one or more computers to perform operations comprising:
receiving, by one or more computing devices, a write request including a table with one or more columns to be stored in a storage device, wherein each column includes a number of pages;
generating a column key for each column and a page key for each page including sensitive information;
encrypting (i) each page including sensitive information with a corresponding page key and (ii) each column with a corresponding column key;
generating wrapped keys for the column keys and page keys and storing the wrapped keys into a key file;
storing the encrypted columns into a data file of the storage device and storing the wrapped keys in a separate key file; and
storing a reference to the key file in a file footer of the data file.

18. The computer-readable storage media of claim 17, wherein the key file is in a dedicated space in a shared file system that requires permission to access.

19. The computer-readable storage media of claim 17, wherein each wrapped key includes an identifier of a data key and location information of data that is encrypted using the data key.

20. The computer-readable storage media of claim 19, wherein the wrapped key is signed using a wrapped key signing key.
